(19) United States
(12) Patent Application Publication
(10) Pub. No.: US 2009/0101170 A1
(43) Pub. Date: Apr. 23, 2009

(54) SYSTEM FOR SOAKING ROLLS OF ABSORBING MATERIAL TO BE USED IN PRINTING MACHINE CLEANING

(76) Inventor: Arrio Vavassori Bisutti, Bergamo (IT)

Correspondence Address: SCHNECK & SCHNECK, P.O. BOX 2-E, SAN JOSE, CA, 95109-0005, US

(21) Appl. No.: 12/293,326

(22) PCT Filed: Sep. 13, 2007
(86) PCT No.: PCT/IB2007/002695

§ 371 Date: Sep. 17, 2008

(30) Foreign Application Priority Data
Sep. 22, 2006 (IT) MI2006U000327

(51) Int. Cl. B08B 7/00; B05C 3/00

(52) U.S. Cl. 134/6; 118/400

(57) ABSTRACT

System for soaking absorbing material rolls or sheets (1b, 2b) with a solvent (1a, 2a), such a solvent being contained into a bag made of plastic divided into two separated partitions, one (A) suited to contain the solvent, and the other (B) to contain the sheets or rolls (1b, 2b) of absorbing material. Such a system is able to allow a contact between the solvent and the absorbing material only when one wants to use the absorbing material in order to clean the printing machines, after soaking it with solvent.

### FIELD OF THE INVENTION

The present invention refers to a system for cleaning printing machines based on pre-soaking, with solvents for inks and paints, the rolls or sheets of non-woven fabric to be used in cleaning printing fabrics and cylinders intended to spread the inks or paints needed for printing into the printing machine.

### PRIOR ART

There exist various systems for cleaning printing fabrics and cylinders intended to spread inks or paints needed for printing. Such a cleaning is to be performed whenever, on the same machine, a subject to be printed is substituted with a new one; or when printing the same subject on a great number of copies, an anomalous building-up of printing ink occurs on the cylinders or the printing fabric, which building-ups could negatively effect the final printing result, or when the type or series of inks is to be changed.

The most simple cleaning system consist in soaking with a suitable printing ink solvent a portion of fabric or fabric feel, such as a non-woven fabric (normally obtained by mixing polyester and cellulose pulp with a small amount of binders of the two basic products), or a portion of absorbing paper, and then manually cleaning the printing machine.

The most simple system provides the use of a portion of absorbing material such as a fabric, a non-woven fabric or absorbing paper soaked with a printing ink solvent. Such an element is commonly defined “cloth” and is used to manually remove ink from fabrics and cylinders of the printing machine by scrubbing.

A more complex system provides the use of a material such as for example a non-woven fabric packaged in rolls having the same width of the printing machine.

Such non-woven fabric rolls are placed into an automatic device, which is aimed to unwrap the roll, spray the non-woven fabric or other absorbing material with a solvent for printing inks, and place the solvent-soaked non-woven fabric into contact with the machine ink-soiled cylinders, making them spin. Thanks to said contact between the solvent-soaked non-woven fabric and the inked cylinders of the machine, the cylinders are cleaned by transfer of ink from cylinders to the solvent-soaked non-woven fabric; the ink-soiled non-woven fabric is then newly wrapped on a shaft of the automatic system, while when a cleaning operation is wanted, the clean non-woven fabric still available on the roll is unwrapped, sprayed with solvent and put into contact with the ink-soiled cylinder of the printing machine. By said process, which prolongs until the end of the non-woven fabric wrapped on the roll, various cycles of total cleaning of cylinders and printing fabrics are obtained.

The above-said cleaning system is the most common and requires and automatic device provided with various components, among which: a solvent tank, solvent distribution pumps, a series of spraying nozzles allowing a consistent spreading of the solvent on the non-woven fabric, a system for recovering exhaust or exceeding solvent, and also all is needed to unwrap the clean non-woven fabric roll and then wrap back the used, and thus ink-soiled, non-woven fabric.

A third and more recent automatic cleaning system provides the use of non-woven fabric rolls which are pre-soaked with solvent and packaged in sealed plastic packages to allow their shipping and storing. Such rolls, which are originally pre-soaked by manufactures, are placed into an automatic device consisting of an apparatus only provided with an unwrapping device for clean non-woven fabric and a wrapping back device for soiled non-woven fabric. The device used in such a system is much simpler, since the use of a pre-soaked non-woven fabric does not require a solvent tank, distribution pumps, spraying nozzles and systems for recovering exhaust or exceeding solvent.

This third cleaning system is the subject matter of U.S. Pat. No. 5,368,157 by C. R. Gasparrini and W. H. Cano and its subsequent update filed with the U.S. Pat. No. 5,974,976 in the name of the same authors.

The limitations of the above method are represented by those problems arising from a long-time residence of the solvent pre-soaked rolls in store-houses. As a matter of fact, a non-woven fabric in long-time contact with the solvent macerates and looses part of its traction strength; such loss of strength greatens the longer the non-woven fabric is soaked with solvent. The solvent, in its turn, looses part of its chemical characteristics by reacting with the non-woven fabric and, above all, with the binders used for manufacturing the same. Moreover, the air contained into the non-woven fabric tends to oxidize the solvent, consequently reducing its cleaning capacity.

Therefore, a need was felt to create new systems designed to clean printing fabrics and cylinders used to spread those inks and paints required for printing, which are able to overcome the poor efficiency and poor inexpensiveness drawbacks of manual methods, as well as the harmful effects the manual treatment can have on the operator who is forced to handle and breath variously dangerous solvents. Such new systems are able to overcome also problems related to complexity, continuous maintenance, risk of in-series manufacturing interruptions, and thus high management costs for automatic cleaning systems comprising absorbing material rolls soaked by nozzle sprays. Moreover, a need was felt to overcome the drawbacks of maceration, loss of breaking load, deterioration of materials (respectively constituting the non-woven fabric roll and the soaking solvent) because of the long-time mutual contact. A need was also felt to avoid solvent oxidation by the air into the material forming the absorbing material roll (also in case of suction, although partial, of the air contained into the material constituting the roll), which is peculiar of those systems providing non-woven fabric rolls pre-soaked with ink or paint solvent placed into sealed containers.

An alternative to said system is the object of the international patent application n. PCT/IT03/00460 filed by Arrio Vavassori Bisutti, which provides the use of non-woven fabric rolls placed into a suitable container provided with a suitably bored lid, to which a plastic bag or blister containing the solvent is superimposed. Such a bag can be pierced by piercing means that, when subjected to a moderate pressure, allow the solvent contained in it to flow out so as to drop into the suitably bored container and, from that on the rolls there below, in order to soak consistently the all surface of the non-woven fabric rolls below only when they are going to be used.

This new system is preferable with respect to the prior one, since it eliminates those problems related to the aging of the pre-soaked product and the need of particular care in storing and shipping, which are to be performed while keeping the rolls horizontal in order to avoid that, in case of vertical position, the solvent accumulates on the bottom of rolls leaving their upper part dry. In this case, as a matter of fact, the rolls would not be able to consistently clean the inked fabrics or cylinders.

However, the process of pre-soaking remains complex and expensive, providing an assembly or kit comprised of:

a) a basing housing the rolls, b) a bag containing the solvent, c) a piercing means, generally comprised of blades or thorns able to break the solvent-containing bag, d) a lid or a suitably bored basin intended to gather the solvent released by the bag after breaking, and aimed to slow-down the solvent dropping on the rolls, in order to obtain a consistent spreading on the rolls below. Moreover, the drawbacks derived by the waiting times needed to completely soak the rolls and emanation of vapors when using volatile solvents during preparation of soaked rolls, still remain.

### SUMMARY OF THE INVENTION

The applicant, continuing the researches in this technical field, has realized a new system for soaking sheets or rolls of absorbing material with a solvent or a mixture of printing ink or paint solvents designed to clean printing machine cylinders and fabrics, which comprises a bag made of a material that is flexible and impervious to printing ink and paint solvents (preferably made of plastic), which bag is divided in at least two communicating sections or partitions suitable to contain the solvent or mixture of solvents (the section or partition “A”) and one or more rolls or sheets of absorbing material (the other section or partition “B”).

Said sections or partitions being mutually contiguous on one or more side(s)/dimension(s) of the bag.

Said sections or partitions being kept mutually separated by means of removable seal, in order to allow the solvent to flow out into the partition containing the absorbing material and assure a uniform and consistent distribution of solvent on the absorbing material.

The sections or partitions of the bag being mutually communicating by means of openings having sections dimensioned so as to allow, after removal of the partitioning seal, a stepwise flowing out of the solvent when the absorbing material placed into the “B” section or partition is to be soaked.

A further object of the present invention is a process for soaking sheets or rolls of absorbing material with a solvent or a mixture of solvents for printing inks or paints, intended to clean printing machine cylinders and fabrics, which comprises the soaking system of the present invention, and particularly wherein a bag made of a material that is flexible and impervious to printing ink and paint solvents, preferably made of plastic, is divided by partitioning seal(s) in at least two communicating sections or partitions, which sections or partitions are mutually contiguous on one or more bag sides/dimensions, one containing the solvent or mixture of solvents, while the other can house one or more rolls or sheets of absorbing material. Said sections or partitions being mutually communicating by means of openings allowing, after removal of the partitioning seal(s), a stepwise flowing out of the solvent into the section or partition containing the absorbing material, preferably a non-woven fabric, and said sections/partitions being communicated only when soaking is to be performed, after removal of partitioning seal(s).

A further object of the present invention is a method for cleaning printing cylinders and fabrics, comprising the use of a soaking system, or including a soaking system as described above, also an object of the present invention.

### DESCRIPTIONS OF DRAWINGS

FIG. 1 shows a perspective view of the plastic bag divided into two sections, respectively (A) containing the printing ink solvent (1a), and (B) containing the non-woven fabric roll (1b). The two sections of the bag communicating by means of openings (1c, 1c₁, 1c₂, 1c₃) suited to allow the solvent flowing out, but kept separated by a removable partitioning seal (1d) to be removed when the soaking of the absorbing material roll is to be performed, so as to use it for cleaning printing machine fabrics and cylinders.

FIG. 2 shows a perspective view of the plastic bag divided into three sections, respectively (A) and (A′) containing the printing ink solvent (2a), and (B) containing the non-woven fabric roll (2b). The three sections of the bag communicating by means of openings (1c, 1₁, 1c₂, 1c₃) suited to allow the solvent gradual flowing out, but separated by sealing devices (2d), (2d₁) (removable partitioning seals) to be removed when the soaking of the absorbing material roll (2b) is to be performed.

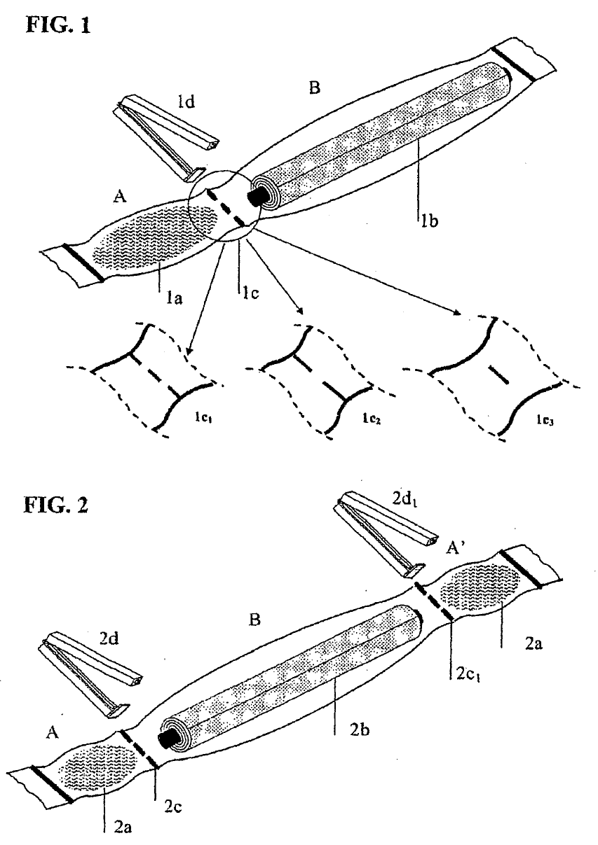

### DETAILED DESCRIPTION OF THE INVENTION

An object of the present invention is therefore a soaking system for absorbing material sheets or rolls with a solvent or a mixture of solvents for printing inks or prints, to be used in cleaning printing machine cylinders and fabrics, which comprises a bag made of a material that is flexible and impervious to ink or paint solvents, preferably made of plastic, which bas is divided in at least two contiguous sections or partitions on one or more sides/dimensions of the bag, partition or section (“A”) being suited to contain the solvent or mixture of solvents, and partition or section (“B”) being suited to contain one or more rolls or sheets of absorbing material, said partitions or sections being divided by removable partitioning seals in order to clear one or more openings communicating said partitions or sections, thus allowing a stepwise outflow of the solvent into the partition or section containing the absorbing material, preferably said openings having sections sized so as to allow an outflow fast enough to informingly and consistently spread the solvent on the absorbing material.

The partitions or sections of the bag are divided by said partitioning seals to be removed when a soaking step is to be performed, in order to allow the inflow of the solvent into the section or partition (“B”) containing one or more rolls or sheets of absorbing material.

In another embodiment of the system of the present invention, the sections or partitions which the bag is divided into are at least three parts, the central of which contains one or more rolls of absorbing material or one or more sheets of absorbing material, preferably a non-woven fabric, and the side ones containing the solvent or mixture of solvents designed to soak the absorbing material.

In another embodiment of the system of the present invention the bag, which is divided into various sections or partitions, contains only one element, that is one or more rolls or sheets of absorbing material, preferably a non-woven fabric, or the solvent or mixture of solvents, while the other element is into the bag during soaking.

In another preferred embodiment of the present invention, the system is characterized by comprising a device placed outside of the bag (a removable partitioning seal) which separates the sections or partitions the bag is divided in.

In another preferred embodiment of the present invention, the system is characterized by comprising a device placed inside the bag (a removable partitioning seal) which separates the sections or partitions the bag is divided in.

In another preferred embodiment of the present invention, the bag is divided in at least two sections or partitions reciprocally separated in order to avoid contacts between the elements contained therein, that are respectively the solvent and the absorbing material, and is made of a material selected from the group including plastic, waterproofed fabric, waterproofed or plasticized paper or cardboard, metallized paper or metallized plastic film, or combinations thereof.

In another preferred embodiment of the present invention, the absorbing material forming one or more rolls or sheets is a non-woven fabric, paper or cloth.

Particularly, in the system of the present invention, the solvent or mixture of solvents is one or more solvents selected from low, medium or high volatile solvents.

Particularly, in the system of the present invention, the solvent or mixture of solvents is in an amount that is at least the amount needed to soak precisely the one or more rolls or sheets of absorbing material.

Said amount is easily computable, being it related to the chemical nature and quantity of the absorbing material constituting the roll, and to the chemical nature of the printing ink or paint solvent to be used, and thus to the capacity of absorbing that particular solvent by the roll(s) of absorbing material into the bag.

The most used method to verify such an amount is weighting a sample of absorbing material having a known surface, for example 10 cm², and then weighting the same sample after its complete dipping into the solvent and trickling for a couple of minutes. The difference between the two weightings is the absorption capacity in gr/cm² with reference to the absorbing material type and the solvent used.

That is a further specific advantage to the soaking system and relevant cleaning process and method, as herein described objects of the present invention.

In another preferred embodiment of the present invention system, the solvent or mixture of solvents is selected from a group consisting of organic solvents, both aliphatic and aromatic compounds or mixtures thereof, and suspensions or emulsions or water dispersions of said organic solvents. More preferably, said solvent or mixture of solvents is selected from a group consisting of solvents based on essential oils or solvents based on mineral oils, or hydrocarbon solvents.

Another object of the present invention is a process for soaking the rolls or sheets of absorbing material with a printing ink or paint solvent or mixture of solvents designed for cleaning printing machine cylinders and fabrics, said process being characterized by a bag made of a material that is flexible and impervious to printing ink and paint solvents, preferably made of plastic, which bag is divided by removable partitioning seals into at least two sections or partitions which are contiguous on one or more side(s)/dimension(s) of the bag, one of them containing the solvent, while the other can house one or more rolls or sheets of absorbing material, said sections or partitions communicating by openings allowing a stepwise outflow of the solvent into the section or partition containing the non-woven fabric roll, said sections/partitions being mutually communicated only when a soaking is wanted after removing the partitioning seal(s).

Another object of the present invention is a method for cleaning the printing cylinders and fabrics, comprising the use of a soaking system of the present invention as described above.

In another embodiment of the cleaning method of the present invention using the soaking system described above, the elements designed to clean printing machine cylinders and fabrics, i.e. a solvent or mixture of solvents, and one or more rolls or sheets of absorbing material, are kept separated and put into contact only when the absorbing material, preferably a non-woven fabric, is to be soaked with solvent.

Another object of the present invention is a method for cleaning the printing cylinders and fabrics, comprising a process for soaking sheets or rolls of absorbing material with a solvent or a mixture of solvents for printing inks or paints, in order to clean printing machine cylinders and fabrics, said process being characterized by a bag made of material that is flexible and impervious to printing ink and paint solvents, preferably made of plastic, which bag is divided by removable partitioning seals into at least two sections or partitions which are contiguous on one or more side(s)/dimension(s) of the bag, one of them containing the solvent, while the other can house one or more rolls or one or more sheets of absorbing material, said sections or partitions mutually communicating by openings allowing a stepwise outflow of the solvent into the section or partition containing the non-woven fabric roll, said sections/partitions being mutually communicated only when a soaking is wanted after removing the partitioning seal(s).

The soaking system, the related process and consequent cleaning method as described above according to the present invention comprise as main part a fabric roll or sheet, preferably wrapped on a core, such as an elongated cylindrical core made of a plastic pipe. Said core can also be made of cardboard and/or metal, such as steel, aluminum and the like. Said core is suited to be placed into the cleaning devices, one for wrapping and the other for unwrapping said fabric rolls into the automatic cleaning devices of printing machines, in order to vigorously scrub the fabric soaked with solvent against the spinning cylinder to be cleaned.

In particular, as to the method for cleaning printing machine cylinders and fabrics according to the present invention, said method means that, after soaking the absorbing material by means of the system and process described above, the bag in which soaking is performed is opened, preferably by suited cutting devices, and said soaked material drawn from the bag is ready to be used in automatic cleaning devices for printing machines.

The soaking system, the related process and consequent cleaning method as described above according to the present invention have the following advantages with respect to the existing ones:

I. There is no limit to the preservation times of products, since the physical separation of the two components (the material forming the fabric of the non-woven fabric roll, and the solvent) avoids their interaction, thus creating advantages with respect to storing, shipping and preservation of products.

II. Optimal efficiency conditions of the system are assured, both from a chemical point of view, with respect to the solvent, and from the physical and mechanical ones, with respect to the breaking load of the material forming the fabric. As a matter of fact, the solvent outflow and consequent soaking of the fabric are performed when using the cleaning system.

III. An optimal metering of solvent is assured, that is an amount which exactly matches to the absorption capability of the fabric surface corresponding to the non-woven fabric type or, in any case, to the absorbing material to be soaked, as well as to the cleaning systems needs.

IV. Any expensive air suction from the absorbing material is made superfluous, since it can be used in its original state, as such air suction has as sole aim to avoid or slow down the solvent oxidation in case of a long-time residence into contact with the absorbing material.

V. Maximum safety during handling and shipping of the product packages is guaranteed, since even in case of accidental break of the bag, the solvent contained in it would be totally absorbed by the absorbing material without risks of any harmful leaking.

VI. The use of any kind of solvent suited for printing inks and paints is allowed, said solvent being organic or inorganic, and a low, medium or high volatile solvent.

VII. All costs related to piercing and spreading solvent after the bag's break to allow a uniform and consistent soaking of the non-woven fabric rolls are eliminated.

VIII. All costs related to the plastic basin or container needed to contain the absorbing material during soaking are eliminated.

1. System for soaking absorbing material rolls or sheets with a solvent or a mixture of solvents for printing inks or paints, to be used for cleaning printing machine cylinders and fabrics, which comprises,
a bag having bag sides and made of a material that is flexible and impervious to fluid printing ink and paint solvents, divided in at least two contiguous sections on at least one of the bag sides with a first section suited to contain a solvent or mixture of solvents, while a second section contains at least one roll or sheet of absorbing material, said sections being mutually divided by at least one removable partitioning seal to clear at least one opening that mutually communicate fluid solvent between said sections allowing a stepwise flowing out of the fluid solvent into the section containing the absorbing material.

2. System according to claim 1, whereby said openings communicating fluid solvent between the sections are openings formed to allow an outflow having enough speed to allow spreading of the solvent on the absorbing material uniformly and consistently.

3. System according to claim 1, wherein the sections of the bag are divided into at least three, including a central section between two lateral sections, the central section containing at least one sheet of absorbing material and the lateral sections containing the solvent or mixture of solvents.

4. System according to claim 1, wherein the bag sections are divided into at least three, including a central section between two lateral sections, the central section containing solvent between at least one roll or sheet of absorbing material in each of the lateral sections.

5. System according to claim 1, wherein the removable partitioning seal dividing the bag sections is out of the bag.

6. System according to claim 1, wherein the removable partitioning seal dividing the bag sections is inside of the bag.

7. System according to claim 1, wherein the bag is comprised of a material selected from the group consisting of plastic material, waterproofed fabric, waterproofed paper or cardboard, metallized paper, and metallized plastic film.

8. System according to claim 1, wherein the absorbing material is non-woven fabric, paper or cloth.

9. System according to claim 1, wherein the solvent or mixture of solvents is comprised of one or more solvents selected from low, medium or high volatile solvents.

10. System according to claim 1, wherein the solvent or mixture of solvents is in an amount corresponding at least to the amount of solvent needed to exactly soak the at least one roll or sheet of absorbing material.

11. System according to claim 1, wherein the solvent or mixture of solvents is selected from a group consisting of organic solvents, both aliphatic and aromatic compounds or mixtures thereof, and suspensions or emulsions or water dispersions of said organic solvents.

12. System according to claim 1, wherein the solvent or mixture of solvents is selected from a group consisting of solvents based on essential oils or solvents based on mineral oils, or hydrocarbon solvents.

13. Process for soaking sheets or rolls of absorbing material with a solvent or mixture of solvents of the kind used for printing inks and paints, comprising cleaning rolls and sheets associated with printing machine cylinders and fabrics, using the system according to claim 1.

14. Process for soaking sheets or rolls of absorbing material with a solvent or mixture of solvents for printing inks or paints, to be used for cleaning the printing machine cylinders and fabrics, wherein a bag made of a material that is flexible and impervious to printing ink and paint solvents, is divided in at least two contiguous sections on at least one bag side, containing a solvent or mixture of solvents in a first bag section and at least one roll or sheet of absorbing material in a second section, said sections mutually communicating by sealed openings allowing a stepwise flowing out of the solvent into the section containing the rolls or sheets, said sections in communication after removal of seals.

15. Method for cleaning printing cylinders and fabrics, comprising the use of the system according to claim 1.

16. Cleaning method according to claim 14, wherein the solvents and the at least one roll or sheet of absorbing material are kept separated and are put into contact only when the absorbing material is to be soaked with solvent.

17. Method for cleaning printing cylinders and fabrics, comprising a process for soaking absorbing material sheets or rolls with a solvent or mixture of solvents for printing inks and paints, in order to clean printing machine cylinders and fabrics, wherein a bag made of a material that is flexible and impervious to printing ink and paint solvents is divided by removable partitioning seals in at least two contiguous sections on at least one bag side, one section containing a solvent or mixture of solvents, while another section houses one or more rolls or sheets of absorbing material, said sections mutually communicating by openings allowing a stepwise flowing out of the solvent into the section or partition containing the rolls or sheets, said partitions being in communication only after having removed the partitioning seals.
